(19) United States
(12) Patent Application Publication
(10) Pub. No.: US 2022/0030921 A1
(43) Pub. Date: Feb. 3, 2022

(54) CREAM

(71) Applicant: SAVENCIA SA, Viroflay (FR)

(72) Inventors: Fabien Durand, Razac sur L'Isle (FR); Virginie PADEL, FAVIERES (FR); Alice CIBRARIO, Versailles (FR)

(73) Assignee: SAVENCIA SA, VIROFLAY (FR)

(21) Appl. No.: 17/390,477

(22) Filed: Jul. 30, 2021

(30) Foreign Application Priority Data
Jul. 31, 2020 (FR) FR 2008200

(51) Int. Cl. A23L 9/20; A23L 25/00; A23L 29/00; A23L 29/212; A23L 19/12; A23L 19/10

(52) U.S. Cl. CPC A23L 9/24; A23L 25/30; A23L 29/04; A23L 19/11; A23L 29/065; A23L 19/13; A23L 29/212

(57) ABSTRACT

The present invention relates to the field of the food industry; it is aimed more particularly at the preparation of food products, namely a range of cream analogues, composed of vegetable ingredients and having functional and organoleptic properties close to those of dairy products.

The present invention relates to the field of the food industry; it is aimed more particularly at the preparation of food products, namely a range of cream analogues, composed of vegetable ingredients and having functional and organoleptic properties close to those of dairy products.

Whether for ethical conviction or nutritional reasons, the demand for vegetarian or even vegan food products is constantly growing. There are, however, food products whose manufacture by definition requires the use of ingredients of animal origin, as is the case with mammalian milk for the preparation of dairy products such as cheese.

The objective of the applicant is to develop food products analogous to dairy products from vegetable raw materials in order to generate products compatible with a vegan diet while remaining in the organoleptic world of dairy products such as liquid cream, thick cream, full-fat cream, low-fat cream in terms of appearance, texture and taste.

The creams are a category of dairy products obtained from the liquid milk, a colloidal medium composed of proteins of submicron size, lipid globules, sugars and mineral salts. A skimming method allows to separate the fatty phase (cream) from the aqueous phase (skimmed milk). The cream is potentially enriched with stabilizers or emulsifiers and then subjected to a thermal treatment (pasteurization or sterilization) for a conservation in fresh or at room temperature according to the thermal treatment method.

The dairy analogues are defined as products obtained by mixing different ingredients such as proteins and fats, of dairy or non-dairy origin, and formulated to meet a specific functional need (Bachman, H. P., 2001, “Cheese analogues: a review”, International Dairy Journal, Volume 11, 505-515). Historically, these products have been formulated with an objective of reducing costs, in particular with the pizza cheeses. More recently, the segment of the vegetable analogues aiming to reproduce the appearance and taste characteristics of the different cheeses has experienced a strong commercial expansion, and different products are available on the market with various formulation strategies. The world of creams is no exception to this trend and several products are already being marketed around the world.

For example, the vegetable creams obtained by emulsifying fat in an aqueous phase containing texturizers are known, such as the Superbom®, Sunniva Gryr®, Lima® or Kaslink Aito® brand products. These products have a low protein content (between 0 and 1%) and their texturing and their stabilization are ensured by the joint use of fat, flours and/or starches and hydrocolloid-type additives (modified starch, agar, carob, xanthan, carrageenans, pectin, etc.). Acids (lactic E270, citric E330, tartaric E334, sorbic E200) can also be used. The absence of protein in these products remains a major point of differentiation compared to dairy referents.

There are also products obtained from soybean seeds such as the references of the brands Fior di Natura®, Alpro®, Sojabio® or Bjorg®. These products often consist of fermented soybeans coupled with the use of additives. One often finds marked vegetal notes such as hay, tobacco, earthy; organoleptic notes characteristic of the soybean.

There are also products obtained from vegetable raw materials that have undergone various treatments such as hulling, thermal treatments, crushing, fermentation and even germination. These vegetable raw materials are mainly seeds such as the rice (Veganz® brand product, Alpro®), the oats (Oatly® brand, Hafer cream from DM Bio® or Veganz®) and nuts. Among the nuts, the cashew nut and the almond are the most frequently used. The cashew-based products are sold under the Forager® brand and almond-based products under the Soyana® and Ecomil® brands. These products most often contain additives to texturize or stabilize the emulsions.

In conclusion, the vegetable cream analogues of the prior art are most often
either starch and/or hydrocolloid solutions in which fat is emulsified, with a very low protein content (<1 g/100 g).
Or soybean-based solutions, most often fermented with or without additives.
or nut suspensions supplemented with either additives or vegetable proteins with reduced protein contents of the order of 1-3%.

The objective of the Applicant is to obtain a range of vegetable creams with smooth and more or less thick textures from crushed nuts with a protein content >3.5%, which can have a very good nutritional profile, in particular through a limited content of saturated fatty acids, and this without resorting to the addition of additives such as gums and modified starches.

Vegetable cream means a product formulated with vegetable raw materials that is as close as possible to a dairy cream in terms of texture and of the organoleptic profile. In the rest of the document, the term cream will be used to describe this type of product with the possibility of specifying depending on the texture (liquid cream, thick cream) or the conservation mode (long-life UHT cream, pasteurized cream) required.

The obtaining of vegetable analogues of dairy products poses many technical problems. Unlike the milk, which is a liquid, the vegetable materials are in the form of cohesive solid materials often organized in a complex manner with well-differentiated tissues having specific biological functions (e.g. germ and endosperm in a cereal). It is therefore difficult to obtain a smooth, unctuous and homogeneous product (on a scale of less than a millimeter) from vegetable particles larger than a centimeter, which tend to produce pasty and/or granular products.

It is also difficult to obtain a product with a dairy typicity from vegetable raw materials, in particular the white color which allow to remind the world of cream.

Another problem is to completely free ourselves from animal raw materials, such as dairy proteins or eggs, whose texturizing, binding, gelling, stabilizing, emulsifying, whipping, etc. functionality could be put to good use.

A similar technical problem is to have a finished product without additives such as emulsifiers, gums and other hydrocolloids (modified starch, agar, carob, xanthan, carrageenan, pectin, etc.), ingredients commonly used in the vegan creams for their texturizing and stabilizing properties: the texturizers modify the rheological behavior of creams, making them more or less thick, unctuous, smooth, stable and compatible with culinary applications (sauce, pie, pizza, etc.). They also have a stabilizing role through their ability to bind free water, thus limiting the risks of syneresis (water exudation) and dephasing on the finished product, phenomena perceived as a quality defect. They also minimize the risk of obtaining a “floury” texture (granular or grainy structure) by limiting the interactions between proteins and fats that can conduct to the formation of aggregates of perceptible size in the mouth. The hydrocolloids are classically used, alone or in a mixture, possibly in the presence of emulsifiers, which allows the formulator to adjust the level of texture of the creams while guaranteeing the stability of this texture over time.

In the case of a thick cream, another technical problem is to use mostly fluid oils rather than hard fats, which are solid at low temperatures and give a creamy, melting texture to the cream. Furthermore, the Applicant has observed that the use of liquid oils is likely to increase the risk of dephasing during a prolonged storage and/or when the cream is used in cooking.

The use of hard fats such as coconut oil, palm oil or cocoa butter is widespread in the world of vegetable cream analogues: for example, the products of the brands Ays Kro®, Dr Oetker®, Forager Project® or Soyana® contain between 15 and 30% copra, a fat that contains more than 90% saturated fatty acids (SFA) out of the total fatty acids. This quantity and quality of fat (very hard) generates a texture close to a cream after storage at a temperature less than or equal to 10° C.: using instead a fluid oil at this temperature conducts to a significant deficit of texture that must be filled. No commercial vegetable product on the market meets the requirement of using an almond puree without using additives (hydrocolloids and/or acidifiers) or hard fats to structure and stabilize the cream.

It is also difficult to obtain a vegetable cream that has the sensory profile of dairy product and in particular the characteristic butter-cream notes. The aromatic profile often comprises detectable vegetable notes that may not be suitable for some consumers seeking a sensory experience similar to a dairy product experience.

Thanks to a specific selection of vegetable raw materials, coupled with a mastery of the fermentation as well as a method allowing to generate more or less textured creams, the Applicant has succeeded in preparing food products composed of vegetable raw materials and which present organoleptic qualities reproducing those of dairy creams without resorting to the use of additive or additives, with a protein content higher than 3.5% and with excellent behavior during culinary applications, sometimes even better than that of the dairy creams. For example, the texture is more stable when used hot as a topping on pizzas, quiches or sweet pies, despite the temperature changes.

Advantageously, this selection of vegetable raw materials allows to offer products with:
a significant protein and optionally food fibres content
a low SFA content,
“Clean Label” formulations, i.e. devoid of food additives, with nutritional profiles potentially superior to cheese equivalents, in this case via a Nutri-Score that can be A to B. The Nutri-Score is a nutritional quality assessment tool introduced in 2016 in France in the scope of the National Nutrition and Health Plan. According to its nutritional characteristics, a food product obtains a Nutri-Score score ranging from A (the most nutritionally favorable products) to E (the least favorable products, whose consumption should be limited)
a compatibility for UHT methods, and
a long-term storage capability.

The absence of texturizing-type additives (modified starch, agar, carob, xanthan, carrageenan, pectin, etc.) in the formulas also had to be compensated for by ingredients of the starch and/or flour type. This compensation is not without consequences and has led in particular to three new technical problems:
An organoleptic degradation of the product with an increase in undesirable vegetable tastes and odors and a loss of whiteness. In fact, in addition to the vegetable notes and colorings that are classically more pronounced in ingredients such as flour or starch than in texturizers agents such as additives, the contents incorporated for a similar texturizing effect are much higher, which worsens the organoleptic defects of taste and color. It is then important to choose ingredients that allow to limit/remove these defects.
A greater evolution of texture during the lifetime of the product with, in particular, phenomena of retrogradation of the starch observed, synonymous with an increase in firmness or which can also generate a sedimented deposit during the storage at 4-6° C.
A more delicate behavior during culinary applications such as in particular cooking tests or acidic conditions.

The present invention also allows to solve the problem of composition of most of the vegetable “creams” which contain very little (less than 1%) of protein. The products according to the invention classically contain between 3.5 and 6% by weight of protein without requiring the addition of protein concentrate or isolate and therefore have an improved nutritional profile compared to the vegetable creams of the prior art, with Nutri-Score scores of A to D for the preferred values.

Finally, the present invention allows to get around the problems of taste, color and texture defects frequently found in the vegetable creams analogues. Contrary to the products currently on the market, the products resulting from this invention are very close to the dairy equivalents on these 3 criteria.

Obtaining smooth, greedy and stable textures for Vegan products with a vegetable protein content of more than 3.5% without texturizer or stabilizer agents remains a major technical difficulty. The present invention thus allows to respond to this problem through the implementation of formulae levers and methods that generate textures without floury defect or dephasing.

Similarly, the white aspect of a Vegan product with significant protein content is a real difficulty but remains an essential element to recall the dairy equivalent. There are many Vegan products on the market that look white but are based on formulations such as water+oil+texturizers and therefore without protein. Here again, in order to get around this technical difficulty, formulae levers (choice of the right raw materials) and methods (mixing and homogenization steps) have allow to achieve an appearance identical to that of a dairy cream.

The present invention thus relates to a vegetable food product analogous to a dairy cream, comprising:
crushed nuts, preferably in the form of puree and preferably almond puree;
   with the addition of:
at least one vegetable fat;
at least one source of starch;
at least one natural acidifying ingredient
optionally, at least one source of vegetable food fibres; and
water;
   characterized in that it contains no added additives.

By “no added additives” is meant in particular the absence of additives declared in the list of ingredients of said vegetable food product, in particular on the pack of said vegetable food product.

For example, the salt (which may be an ingredient of said vegetable food product) may contain one or more anti-caking agents, which are not added additives.

The added additive is in particular a food additive, as for example defined below.

According to an embodiment, the vegetable food product has a protein content greater than 3.5%.

According to a particular embodiment, the vegetable food product contains between 3.5 and 6% protein, and more preferably between 3.5 and 5%, 4 and 6%, or 4 and 5% protein.

According to a particular embodiment, the vegetable food product does not comprise protein concentrate and/or isolate, in particular protein concentrate and isolate.

It should be noted that the vegetal notes brought by these proteins at high dosage can often degrade the organoleptic profile of the finished products.

By “concentrate” is meant in particular a concentrate as defined in the Codex Alimentarius, in particular a product containing more than 65% and less than 90% protein.

By “isolate” is meant in particular an isolate as defined in the Codex Alimentarius, in particular a product containing 90% or more protein.

According to an embodiment, the vegetable food product does not comprise a protein source other than the crushed nuts.

According to an embodiment, the vegetable food product does not comprise soybean.

Indeed, it appears that some consumers may have reservations about products containing soybean.

By “natural acidifying ingredient” is meant, for example, a citrus-based ingredient, in particular lemon or grapefruit.

According to one embodiment, the natural acidifying ingredient is an acidifier of the concentrated lemon juice or concentrated grapefruit juice or other citrus fruit type, in particular an acidifier of the concentrated lemon juice type.

More specifically, the present invention relates to a vegetable food product comprising (percentages expressed by weight with respect to the total weight of the product):
from 5 to 30%, preferably between 10% and 20% of crushed nuts, preferably in the form of a puree. The particles of said puree preferably have a median particle size measured by laser particle size measurement of less than or equal to 50 μm;
from 5 to 40% of vegetable fat, preferably from 10 to 25% and even more preferably from 10 to 20%;
from 0.5 to 10%, preferably from 1 to 6%, even more preferably from 1% to 4% of a starch source such as vegetable flour or starch;
up to 30% of other raw materials, preferably vegetable, such as aromas, sugars, ferments, coloring foods, etc.;
up to 8% of vegetable food fibres;
optionally addition of a natural source of calcium such as Lithothamnion; depending on the calcium content of the Lithothamnion powder used, this ingredient can be added at a content of between 0.5 and 1%;
up to 3.5% of acidifier of the concentrated lemon juice type; according to a particular embodiment which does not use a natural source of calcium, the acidifier may be used in a lower content which may be up to 1.8%;
up to 1.5%, preferably less than 0.5% and even more preferably less than 0.2% of food salt;
optionally, up to 1% ferments; if the ferment is used to ferment all or part of the crushed nut, its content may be reduced to 0.2%;
water, between 50% and 75%, preferably around 70%.

According to an embodiment, the present invention relates to a vegetable food product comprising (percentages expressed by weight with respect to the total weight of the product):
from 5 to 30%, preferably between 10% and 20% of crushed nuts, preferably in the form of a puree. The particles of said puree preferably have a median particle size measured by laser particle size measurement of less than or equal to 50 μm;
from 5 to 40% of vegetable fat, preferably from 10 to 25% and even more preferably from 10 to 20%;
from 0.5 to 10%, preferably from 1 to 6%, even more preferably from 1% to 4% of a starch source such as vegetable flour or starch;
up to 3.5% of acidifier of the concentrated lemon juice type; according to a particular embodiment which does not use a natural source of calcium, the acidifier may be used in a lower content which may be up to 1.8%;
optionally, up to 1% of ferments; if the ferment is used to ferment all or part of the crushed nut, its content may be reduced to 0.2%;
water, between 50% and 75%, preferably around 70%.

According to an embodiment, the vegetable food product comprises:
from 15% to 30% of crushed nuts, preferably in the form of a puree;
from 5 to 25% of vegetable fat, preferably from 10 to 25% and even more preferably from 10 to 20%.

According to an embodiment, the vegetable food product comprises:
from 5 to 20%, preferably between 5% and 15% of crushed nuts, preferably in the form of a puree;
from 10 to 40% of vegetable fat, preferably from 20 to 40% and even more preferably from 25 to 40%.

This product is characterized by:
a dry extract content of between 20 and 50%, preferably between 25 and 40%;
a pH between 4.0 and 5.2;
characteristics of a fresh dairy product, in particular white color, smooth appearance, very smooth and dispersing texture in the mouth, from liquid to thick depending on the type of cream desired and a fresh to fermented/acidic taste.

Smooth texture in the mouth means a particle size distribution with a median diameter of less than 50 microns, which is the order of magnitude of particles that are sensorially perceptible in the mouth.

If necessary, the color can be adjusted, for example to a “cream” color, in particular by adding a coloring food.

Preferably, this food product does not contain any other ingredient than those listed above and detailed below; in particular, it is free of any product of animal origin, in particular proteins, lactose, and food additives.

Food additive means a substance added to foods for a technological purpose: to improve its conservation, to reduce the oxidation phenomena, to color the food, to reinforce its taste, etc., it may be coloring agents (including bleaching agents), conservatives, antioxidants, acidifiers and/or acidity correctors, in particular sodium bicarbonate or pH buffers, and texturizing agents (stabilizer, emulsifier, thickener, gelling agent). The use of food additives is governed by the Regulation (EC) No 1333/2008 and these substances are identified by a code in the format “E” followed by a number.

The food product according to the invention is also free of any soybean-based ingredients. In addition, the food product according to the invention does not contain any protein isolate or concentrate, whether of animal or vegetable origin, nor any cereal milk or leguminous.

Nuts: the food product according to the invention consists of a base of one or more nuts, for example chosen from: almond, hazelnut, walnut, cashew nut, pecan nut, Brazil nut, Macadamia nut, alone or in a mixture; preferably, it is a nut puree, preferably of white almonds. A puree is a preparation of finely crushed nuts without any added ingredients, preferably resulting from a very fine crushing method (median particle size of less than 50 μm) and carried out on peeled, blanched and unroasted nuts.

According to an embodiment, the nut is, or the nuts comprise, almonds.

The almond is likely to allow, if necessary, to obtain analogues of cream having an aromatic profile devoid of undesirable notes, i.e. in particular notes not belonging to the notes of the world of dairy creams. According to a preferred embodiment, the vegetable food product according to the invention is prepared with a whitened almond puree with particle sizes of less than 50 μm and allows the obtaining of a smooth and white texture. The choice of this raw material is also coupled with a mixing and shearing method that allows us to offer textures that are perfectly smooth in the mouth without any floury defect.

Depending on the desired viscosity of the finished product, for example between a liquid cream and a thick cream, the almond puree content can be modulated to reduce or increase the dry extract and in particular the fat and protein content.

Vegetable fat: different sources of vegetable fats can be used: oils liquid at 20° C. such as rapeseed oil, sunflower oil, olive oil, grape seed oil, linseed oil, hemp oil, etc., and hard fats (solid at 20° C.) such as copra, cocoa butter, shea butter, etc., a mixture of different vegetable fats can be used.

The choice of the vegetable fat or the vegetable fats depends on their saturated fatty acid content, which impacts the nutritional profile of the finished product, as well as their color and their organoleptic profile.

Thus, the fats are chosen so that the saturated fatty acid content of the creams does not exceed, for example, if necessary, 13%, preferably 6%, even more preferably 3%, by weight with respect to the total weight of the finished product.

According to a preferred embodiment, the vegetable fats used in the scope of the invention are fluid vegetable oils, i.e. fats which are liquid at room temperature (about 20° C.) and therefore have a very low saturated fatty acid content (less than 15%, preferably 10%). For example, the saturated fatty acid content is less than 10% for the rapeseed oil, less than 12% for the linseed oil and less than 15% for the sunflower oil; advantageously and despite the known sensitivity of the oils to oxidation and the various thermal treatments carried out during the preparation of the product (pasteurization of the mix and hot dosing), the finished product in its packaging is stable over time and no rancid note is perceptible at the end of conservation; preferably, the vegetable oil is chosen from the rapeseed oil, the sunflower oil and the olive oil or their mixture.

It is also possible to use hard fats such as copra, shea, palm or cocoa, but these should be used in low fat creams to avoid a high SFA content.

As with the nut puree, the percentage of fat used directly impacts the texture/firmness of the finished product.

Ferments: these can be used to add taste and/or acidity to the mixture, replacing some of the natural acidifier added. Various ferments can be incorporated into the formulation and are known to the person skilled in the art. These may include in particular mesophilic (Lactococcus lactis ssp lactis and/or cremoris, Lactococcus lactis ssp lactis biovar diactylactis, Leuconostoc lactis and/or Leuconostoc mesenteroides) or thermophilic (Streptococcus thermophilus, Lactobacillus delbrueckii ssp bulgaricus and/or Lacticaseibacillus casei and/or Levilactobacillus brevis and/or Lacticaseibacillus rhamnosus and/or Lacticaseibacillus paracasei), ferments of the Geotrichum candidum or Penicillium camemberti or Pediococcus pentosaceus, Pediococcus acidilactici, Lactiplantibacillus plantarum type, and mixtures thereof.

According to an embodiment, the vegetable food product comprises:
crushed nuts, preferably in the form of puree and preferably almond puree;
   with the addition of:
at least one vegetable fat;
at least one source of starch;
at least one natural acidifying ingredient;
ferments;
optionally, at least one source of vegetable food fibres; and
water.

More specifically, the present invention relates to a vegetable food product comprising (percentages expressed by weight with respect to the total weight of the product):
from 5 to 30%, preferably between 10% and 20% of crushed nuts, preferably in the form of a puree. The particles of said puree preferably have a median particle size measured by laser particle size measurement of less than or equal to 50 μm;
from 5 to 40% of vegetable fat, preferably from 10 to 25% and even more preferably from 10 to 20%;
from 0.5 to 10%, preferably from 1 to 6%, even more preferably from 1 to 4% of a starch source such as vegetable flour or starch;
up to 30% of other raw materials, preferably vegetable, such as aromas, sugars, ferments, coloring foods, etc.;
up to 8% of vegetable food fibres;
optionally addition of a natural source of calcium such as Lithothamnion; depending on the calcium content of the Lithothamnion powder used, this ingredient can be added at a content of between 0.5 and 1%;
up to 3.5% acidifier of the concentrated lemon juice type; according to a particular embodiment which does not use a natural source of calcium, the acidifier may be used in a lower content which may be up to 1.8%;
up to 1.5%, preferably less than 0.5% and even more preferably less than 0.2% of food salt;
ferments, in an amount of 0.01 to 1%, in particular 0.01 to 0.1 or 0.2%, in particular used to ferment all or part of the crushed nut;
water, between 50% and 75%, preferably around 70%.

According to a particular embodiment, the ferments are chosen from Lactococcus lactis ssp lactis, Lactococcus lactis ssp cremoris, Lactococcus lactis ssp lactis biovar diacetylactis, Leuconostoc lactis, Leuconostoc mesenteroides, Streptococcus thermophilus, Lactobacillus delbrueckii ssp bulgaricus, Lacticaseibacillus casei, Levilactobacillus brevis, Lacticaseibacillus rhamnosus, Lacticaseibacillus paracasei, Pediococcus pentosaceus, Lactiplantibacillus plantarum and mixtures thereof.

The ferments can be added at different steps of the method in the form of a leaven composed of a fermented vegetable raw material. It is also possible to add the concentrated ferments directly to the cooled product before dosing.

Various lactic ferments can be used, including in particular commercial products such as Danisco® VEGE Cultures (IFF-DuPont N&B), HOLDBAC® YM VEGE (IFF-DuPont N&B), Yoflex® (Chr Hansen) alone or in combination with LGG® (Chr Hansen) or BB-12® (Chr Hansen).

The addition of ferments to the product according to the invention does not have the effect of texturizing it by a coagulation phenomenon for example.

In the case of the preliminary preparation of a fermented vegetable matrix, also called leaven, it can be obtained in the following way: a nut or a mixture of nuts, in the form of a crushed or puree product, preferably almond puree, is added with water so as to obtain a mixture containing 5 to 30% nuts and then thermally treated in order to eliminate the indigenous flora. This mixture is then fermented to obtain a leaven, as described in Example 5. This base is inoculated with one or more microorganisms, preferably lactic acid bacteria, known by the person skilled in the art as being able to bring dairy notes, including “fresh” and/or “cream” and/or “butter” notes to the fermented product, by fermentation. These strain cocktails can be composed of one or more strains, of one or more species including the following species: Lactococcus lactis ssp lactis and/or cremoris, Lactococcus lactis ssp lactis biovar diacetylactis, Leuconostoc lactis and/or Leuconostoc mesenteroides, Streptococcus thermophilus, Lactobacillus delbrueckii ssp bulgaricus, Lacticaseibacillus casei, Levilactobacillus brevis, Lacticaseibacillus rhamnosus, Lacticaseibacillus paracasei, Pediococcus pentosaceus, Lactiplantibacillus plantarum.

The mixture is then incubated at a temperature favorable to the growth of the inoculated microorganism or the inoculated microorganisms within a temperature range comprised between 20° C. and 45° C. The incubation period is between 15 and 48 hours.

The leaven is then incorporated, for example when mixing the vegetable materials in the preparation of the cream, in an amount of 5 to 60% of the final mixture.

Source of starch: this ingredient may be chosen from the rice flour, the chickpea flour, the pea flour, the fababean flour, the bean flour, the lupin flour, the lentil flour, the chestnut flour, the rice starch, the wheat starch, the corn starch, the tapioca starch, the potato starch etc. preferably the rice flour and/or the potato or manioc fecula is used. The rice flour, for example, is pregelatinized.

Because of its high starch composition (80%), the rice flour is an interesting ingredient to offer Clean Label products without additives. Its white appearance and its relatively neutral taste compared to other flours allows to obtain products very close in appearance and taste to a dairy cream. Finally, the absence of gluten and its non-allergenicity are interesting properties.

For the same reasons, the potato and/or manioc fecula is an ingredient of interest to offer smooth and melting textures without strong impact on the color and the taste.

In addition to the hot viscosity and the organoleptic properties, another criterion that can be taken into account for the choice of the rice flour and/or fecula references is the differences in retrogradation observed. The retrogradation is a phenomenon of recrystallization of the starch (composed of chains of amylopectin and amylose) during the conservation which conducts to a progressive hardening of the product, whose texture becomes less supple and significantly firmer, which can then generate products no longer corresponding to the world of cream.

Several flour and starch references were tested and clearly showed significant differences in the behavior of the products during the aging of the products. This difference may be due to the origin of the product, its composition, or the preparation method used by the supplier. The choice of the type, the origin and the reference of the starch sources can have impacts on the texture and the taste of the product that the person skilled in the art will be able to adjust according to his objectives and preferences, in connection with the shelf life and the mode of use desired for this product.

The references showing the least retrogradation over time are preferred in the scope of the present invention in that they allow to ensure a texture stability of the creams during the storage at 4° C.-10° C.

Other raw materials, preferably vegetable: these raw materials are distinct from the other vegetable ingredients of the recipe (nut puree, oil, flour or starch, fibres); they complement the other listed vegetable ingredients and may be chosen from garlic, fine herbs, herbs of Provence, spices, seeds, sugars, coloring foods, calcium such as an extract of Lithothamnion, fruits, vegetables and cereals in the form of inclusions, pastes or purees, aromas (for example to provide a cream, butter, cooked milk, fresh milk, yoghurt, etc., typicity), and in particular from calcium such as an extract of Lithothamnion, aromas (for example to provide a cream, butter, cooked milk, fresh milk, yoghurt, etc., typicity).

Vegetable food fibres: the food fibres usable in the scope of the invention are:
the soluble fibres with low texturizing properties, such as chicory fibres (inulins and fructooligosaccharides), resistant dextrins or any other indigestible oligosaccharide of vegetable origin, having a low molar mass, a neutral taste, a high solubility in water and a limited tendency to recrystallization; and/or
the texturizing soluble fibers and having an ingredient status such as psyllium, linseeds or chia seeds, or other natural mucilages, the oat brans or certain fruit fibers such as in particular apple and citrus fruits. These texturizing fibers are polysaccharides that increase the viscosity of the cream and can have a stabilizing action on the fat drops.
The type of soluble fibres and the quantity implemented can be adapted by the person skilled in the art according to the desired effect.

A mixture of several vegetable food fibres can be used.

The use of vegetable fibres allows advantageously to formulate products with a A score on the Nutri-S core.

In particular the inulin (chicory fibres) can also be added to the products where a melting and unctuous texture is desired.

The choice of the reference and the origin of the fibres can have impacts on the texture and the taste that the person skilled in the art can adjust according to his objectives and preferences.

Acidifier: concentrated lemon juice is preferred. This ingredient allows the final pH of the product to be between 4.0 and 5.2 to reinforce a sensation of freshness and guarantee a microbiological stability throughout the lifetime of the product.

According to an embodiment, the vegetable food product comprises:
crushed nuts, preferably in the form of puree and preferably almond puree;
   with the addition of:
at least one vegetable fat selected from the vegetable oils liquid at 20° C., in particular from rapeseed oil, sunflower oil, olive oil, grape seed oil, linseed oil, hemp oil and mixtures thereof, in particular the rapeseed oil;
at least one source of starch;
at least one natural acidifying ingredient;
optionally, ferments;
at least one source of vegetable food fibres, in particular selected from soluble fibres, such as chicory fibres, resistant dextrins and psyllium or other mucilaginous fibres such as linseed or chia seed fibres, and mixtures thereof; and
water.

More specifically, the present invention relates to a vegetable food product comprising (percentages expressed by weight with respect to the total weight of the product):
from 5 to 30%, preferably between 10% and 20% of crushed nuts, preferably in the form of a puree. The particles of said puree preferably have a median particle size measured by laser particle size measurement of less than or equal to 50 μm;
from 5 to 40% of vegetable fat, preferably from 10 to 25% and still more preferably from 10 to 20%, chosen from the vegetable oils, in particular from rapeseed oil, sunflower oil, olive oil, grape seed oil, linseed oil, hemp oil and mixtures thereof, in particular the rapeseed oil;
from 0.5 to 10%, preferably from 1 to 6%, even more preferably from 1% to 4% of a starch source such as vegetable flour or starch;
up to 30% of other raw materials, preferably vegetable, such as aromas, sugars, ferments, coloring foods, etc.;
from 1 to 8% of vegetable food fibres, in particular chosen from the soluble fibres, such as chicory fibres, resistant dextrins and psyllium or other mucilaginous fibres such as linseed or chia seed fibres, and their mixtures;
optionally addition of a natural source of calcium such as Lithothamnion; depending on the calcium content of the Lithothamnion powder used, this ingredient can be added at a content of between 0.5 and 1%;
up to 3.5% acidifier of the concentrated lemon juice type; according to a particular embodiment which does not use a natural source of calcium, the acidifier may be used in a lower content which may be up to 1.8%;
up to 1.5%, preferably less than 0.5% and even more preferably less than 0.2% of food salt;
optionally, up to 1% of ferments; if the ferment is used to ferment all or part of the crushed nut, its content may be reduced to 0.2%;
water, between 50% and 75%, preferably around 70%.

Such a vegetable food product is likely to have an A or B score, in particular an A score, in the Nutri-Score.

According to an embodiment, the vegetable food product comprises up to 8% saturated fatty acids, preferably up to 5%, even more preferably up to 3%.

According to an embodiment, the vegetable food product comprises:
crushed nuts, preferably in the form of puree and preferably almond puree;
   with the addition of:
at least one vegetable fat chosen from vegetable fats solid at 20° C., in particular from copra, cocoa butter, shea butter and mixtures thereof, in particular copra;
at least one source of starch;
at least one natural acidifying ingredient;
optionally, ferments;
optionally, at least one source of vegetable food fibres; and
water.

More specifically, the present invention relates to a vegetable food product comprising (percentages expressed by weight with respect to the total weight of the product):
from 5 to 30%, preferably between 10% and 20% of crushed nuts, preferably in the form of a puree. The particles of said puree preferably have a median particle size measured by laser particle size measurement of less than or equal to 50 μm;
from 5 to 40% vegetable fat, preferably from 10 to 25% and even more preferably from 10 to 20%, chosen from hard vegetable fats (solid at 20° C.), in particular from copra, cocoa butter, shea butter and their mixtures, in particular copra;
from 0.5 to 10%, preferably from 1 to 6%, even more preferably from 1% to 4% of a starch source such as vegetable flour or starch;
up to 30% of other raw materials, preferably vegetable, such as aromas, sugars, ferments, coloring foods, etc.;
up to 8% of vegetable food fibres;
optionally addition of a natural source of calcium such as Lithothamnion; depending on the calcium content of the Lithothamnion powder used, this ingredient can be added at a content of between 0.5 and 1%;
up to 3.5% acidifier of the concentrated lemon juice type; according to a particular embodiment which does not use a natural source of calcium, the acidifier may be used in a lower content which may be up to 1.8%;
up to 1.5%, preferably less than 0.5% and even more preferably less than 0.2% of food salt;
optionally, up to 1% ferments; if the ferment is used to ferment all or part of the crushed nut, its content may be reduced to 0.2%;
water, between 50% and 75%, preferably around 70%.

Nutritional composition of the creams according to the invention:

TABLE 1

| | | | | Of which | | |
|---|---|---|---|---|---|---|
| | | | | saturated | Carbo- | |
| | Energy | Protein | Fats | fatty acids | hydrates | Fibres |
| | (kcal) | (%) | (%) | (%) | (%) | (%) |
| Range | 150-390 | 3-6 | 8-40 | 1-13 | 1-10 | 0.5-8 |

The cream according to the invention has the following characteristics:
a color as white as possible to find the codes of the dairy product;
a smooth and unctuous texture, without any floury defect; this is achieved in particular by a particle size distribution of the particles of the cream which have a median particle size D50 of less than 50 microns, preferably less than 40 microns, more preferably less than 30 microns;
a taste as dairy as possible, without undesirable vegetable taste.

The method for preparing the product according to the invention comprises the following steps:

A) optionally, preparing a fermented vegetable raw material by fermentation of a part or all of the crushed nuts in their rehydrated and thermally treated form prior to the inoculation of the ferments;
This step aims to improve the organoleptic profile of the finished product by providing a dairy typicity such as cream, cooked milk, fresh milk or even yogurt. The nut is preferably the almond.
The resulting fermented product may be added in the step B) or between the steps D) and G).
B) mixing the raw materials, which may comprise the fermented vegetable raw material obtained in the step A), via a vigorous shearing and, optionally, preheating, e.g. by means of steam injection or a double wall device;
This step allows the hydration of the ingredients, in particular the powders, until a generally liquid and homogeneous suspension is obtained; it is preferably conducted at a temperature of between 20 and 65° C., for 1 to 30 minutes, with moderate to high stirring in a cooker or a stirred tank; preferably, this step is conducted in a cooker at approximately 50° C., for 5 minutes with a moderate stirring.
C) thermal treating the mixture at a temperature between 75° C. and 140° C., for example by double wall or steam injection (in particular according to the thermal treatment scale applied). In the case of a pasteurized product, the thermal treatment can be performed by double wall or steam injection for 1 to 10 minutes under vigorous shearing. In the case of a product that is not cold, the thermal treatment is preferably performed by injecting steam for in particular a few seconds under vigorous shearing;
This step allows the functionalization of the ingredients and the pasteurization or even sterilization of the raw materials;
The mixture can then optionally be transferred to a buffer tank and maintained at a temperature between 70° C. and 85° C.
D) optional degassing and homogenizing;
This step is preferably conducted between 50 bars and 600 bars, preferably 300 to 500 bars.
This step allows, among other things, a whiter coloring of the base and the obtaining of a stable emulsion and the reduction of the size of particles in order to make the texture smooth.
E) optionally, adding other, preferably vegetable, raw materials (aromatic and/or coloring ingredients or fermented vegetable raw material, etc.);
F) dosing the finished product, in particular in its packaging or in an intermediate container (barrel/skin/bag etc.); the dosing can be performed either hot, at a temperature higher than 70° C., preferably between 74 and 80° C., or cold, preferably at a temperature of less than 10° C.;
G) optionally, cooling between 4 and 10° C.;
H) optionally, in the case of a dosing in an intermediate container, adding other raw materials, preferably vegetable (aromatizing or coloring) and/or ferments, followed by cold dosing of the product in its final packaging.
The ingredients can be added between 4 and 20° C., preferably at 10° C. This embodiment requires a choice of aromatic ingredients that are highly reduced in microbial load to ensure a microbiological stability during the conservation of the product. The addition of ferments allows to improve the organoleptic profile of the product and/or the microbial stability of the finished product. The choice of appropriate ferments is known to the person skilled in the art.

Table 2 lists the unit operations that can be implemented in the method according to the invention and indicated in the following examples:

TABLE 2

| | | | Preferred values |
|---|---|---|---|
| | | | (implemented in the |
| Unitary step | Function | Possible values | following examples) |
| Fermenting raw | Improving the | Fermenting nuts | Fermenting almond |
| materials | organoleptic profile | | juice |
| (optional step) | of the raw materials | | |
| A | by providing a | | |
| | cheesy/dairy typicity | | |
| Rehydrating, | Mixing the different | Mixing temperature | Cooker, mix 5 min at |
| Mixing and | ingredients so as to | between 20 and 65° C. | 50° C. |
| Preheating | obtain a globally | Mixing time between 1 | |
| (optional) the | liquid and | min and 30 min | |
| ingredients | homogeneous | Cooker, stirred tank | |
| B | suspension | | |
| Pasteurizing or | Functionalizing | 75° C. to 140° C. | 82° C., 2 min for |
| ultra-pasteurizing | ingredients by the | From 10 sec to 10 min | a cold storage |
| C | thermal treatment and | | 140° C. 10 sec for |
| | pasteurizing/ultra- | | a non-cold storage |
| | pasteurizing raw | | |
| | materials | | |
| Degassing | Stable emulsion, | 50 to 600 bars | 300-500 bars |
| (optional) and | particle size | | |
| homogenizing | reduction for smooth | | |
| D | texture and | | |
| | texturizing lever | | |
| Injecting | Bringing in markers | No limit for the | |
| ingredients | and/or a | aromatization but | |
| (Optional step) | aromatization | preferably cream, | |
| E | | cooked milk, fresh | |
| | | milk or yoghurt type | |
| | | Max marker size | |
| | | depending on the | |
| | | dosing nozzles | |
| Dosing (final | Dosing the product | Hot dosing >70° C., | T° C. of Hot dosing |
| packaging or barrel) | | or cold dosing | between 72° C. and |
| F | | at <10° C. | 85° C., or cold dosing |
| | | | at temperature <10° C. |
| Cooling | Cooling and texturing | T° C. = 4° C.-10° C. | Storage temperature |
| G | the product to obtain | | between 4° C. and |
| (Optional step) | a base or a finished | | 10° C. |
| | product | | |
| Injecting | Bringing in markers | T° C. = 4-20° C. | T° C.:10° C. |
| ingredients | or aromas or one or | | |
| (Optional step) and | more ferments for a | | |
| dosing in the final | aromatization and/or | | |
| packaging | improving the | | |
| H | conservation of the | | |
| | product | | |

According to another aspect, the invention relates to a vegetable food product obtainable according to a method as defined above.

### FIGURES

FIG. 1 is a photograph of the product of Example 1 which is a vegetable analogue of 18% fat thick cream according to the invention, on a hot fruit pie.

FIG. 2 is a photograph of the product of Example 1 which is a vegetable analogue of 18% fat thick cream according to the invention, on a baked pizza.

FIG. 3 is a graphic representation of the sensory evaluation of a cream according to the invention in comparison with a dairy cream.

FIG. 4 is a graphical representation of the viscosity values at 4° C. carried out on the product of example 1, in comparison with a commercial thick dairy cream.

### EXAMPLES

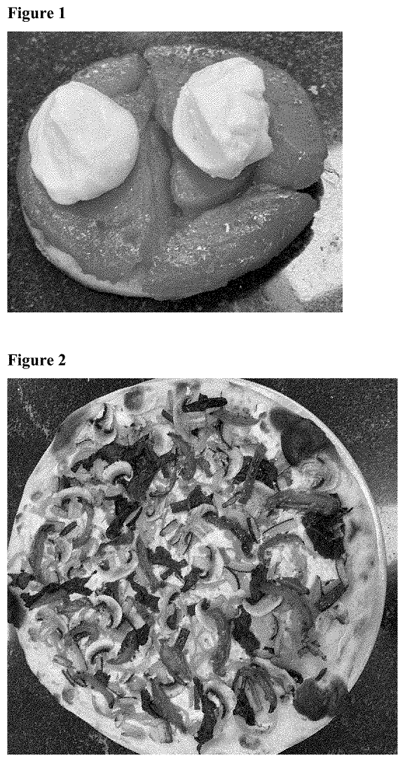

### Example 1 (FIGS. 1 and 2): The Cream-Type Product is Composed of 72% Water, 11% Almond Puree, 13% Shea Butter, 2.5% Potato Fecula, 1.3% Concentrated Lemon Juice, 0.2% Natural Aroma

The method comprises the following steps from Table 3 described above, namely:

(A)-B-C-D-G-H.

The steps indicated in the examples in brackets are optional.
The steps B) and C) can in particular be carried out with a Stephan or Karl-Schnell type cooker using shearing parameters known to the person skilled in the art. In this case, the two mixing steps were carried out at 1500 rpm.
In the case of sterilized products, the thermal treatment is carried out on a UHT equipment according to the methods known to the person skilled in the art.
The result is a finished product having a thick dairy cream with a smooth and unctuous texture in the mouth and a white appearance (see FIGS. 1 and 2). The product has a pH of 4.4 and can be stored before opening for several weeks (70 days) at a temperature of 4 to 10° C. without showing any noticeable evolution in terms of texture or taste. In the case of a sterilized product, the product can then be stored at room temperature.
The nutritional values of the product in Example 1 are shown below:

TABLE 3
Content per 100 g

| | |
|---|---|
| Energy (kcal) | 199 |
| Protein | 3.2 |
| Carbohydrates | 2.8 |
| Of which sugars | 0.5 |
| Lipids | 19 |
| Of which | 6.7 |
| Saturated Fatty | |
| Acids | |
| Fibres | 0.6 |

### Example 2: The Cream-Type Product is Composed of 71% Water, 11% Almond Puree, 13% Rapeseed Oil, 2.5% Potato Fecula, 1% Inulin, 1.3% Concentrated Lemon Juice, 0.2% Natural Aroma

The method comprises the following steps from Table 4 described above, namely:

(A)-B-C-D-G-H

The result is a finished product of Nutri-Score A having the appearance of a semi-thick dairy cream, with a smooth and unctuous texture in the mouth and a white appearance. The product has a pH of 4.4 and can be stored before opening for several weeks (70 days) at a temperature of 4 to 10° C. without showing any noticeable evolution in terms of texture or taste.

TABLE 4
Content per 100 g

| | |
|---|---|
| Energy (kcal) | 204 |
| Protein | 3.2 |
| Carbohydrates | 3.8 |
| Of which sugars | 0.6 |
| Lipids | 19 |
| Of which | 1.76 |
| Saturated Fatty | |
| Acids | |
| Fibres | 1.5 |

### Example 3: The Cream-Type Product is Composed of 69.2% Water, 18% Almond Puree, 9% Rapeseed Oil, 1% Potato Fecula, 1.5% Concentrated Lemon Juice, 1.1% Inulin, 0.2% Natural Aroma

(A)-B-C-D-G-H

### Example 4: Culinary Tests of Vegetable Creams According to the Invention

The cream according to example 1 has been successfully used in various applications such as a mushroom sauce, on a hot fruit pie (FIG. 1), and on a pizza before baking (FIG. 2, taken after baking). In any case, it has an excellent staying power after cooking, better than a dairy cream, which would tend to liquefy.

### Example 5

In the following example, the almond puree with added water was inoculated and fermented with a strain of the Lactococcus lactis ssp lactis biovar diacetylactis specie. The resulting mixture was fermented at 30° C. for 24 hours to obtain what will be called a leaven.

The leaven is then incorporated during the step B) up to 30% in the final mixture.
An unleavened product was also made for comparison. The composition of the two products is equivalent and is summarized in the following table 5:

TABLE 5

| | Product with | Product without |
|---|---|---|
| Ingredients | incorporation of 30% leaven | incorporation of leaven |
| Almond puree | 10.5% | 15% |
| Fermented leaven (15% | 30% | 0 |
| almond puree + 85% water) | | |
| Total almond puree | 15% | 15% |
| Rapeseed oil | 10% | 10% |
| potato fecula | 0.5 | 0.5 |
| Inulin | 1% | 1% |
| Lemon juice | 1.3% | 1.3% |
| Water | 46.7% | 72.2% |

The method implemented is that of example 1.
Both products were made on the same day. During the tasting, the fermented test came out significantly more greedy than the control, with well-marked notes of cream and an organoleptic profile very close to that of a dairy cream.

### Example 6

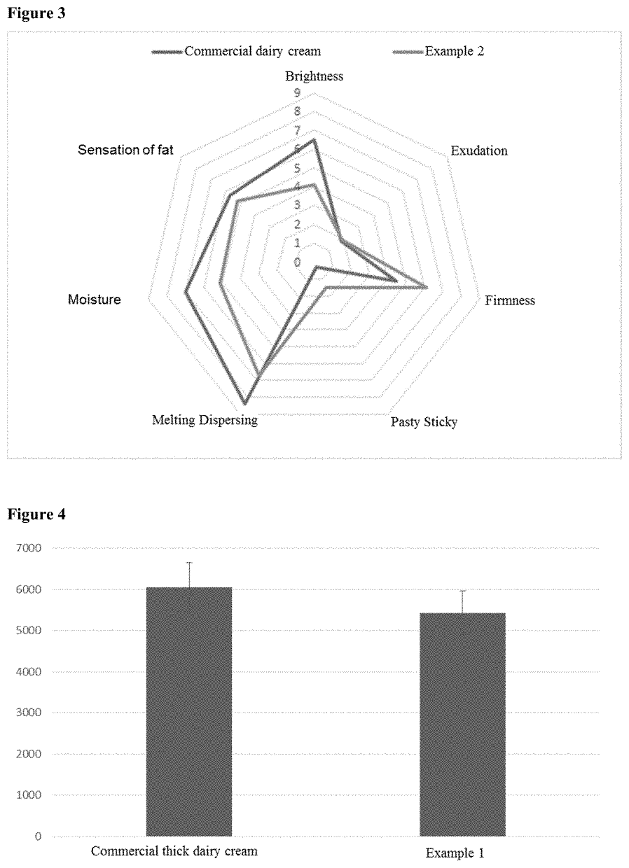

A sensory evaluation was conducted on one of the examples of the invention (the product of example 2) in comparison with a commercial dairy cream.
The evaluation took place on a comparative basis, on products presented anonymously using a 3-digit code.
The jury was made up of 8 participants trained in the descriptive method (Sensory Profile/QDA Quantitive Descriptive Analysis) and in the evaluation of dairy and vegetable products.
About ten descriptors of texture or aspect were evaluated, including: brightness, exudation, firmness, moisture, sensation of fat, melting/dispersing, pasty/sticky
The products were rated on a continuous 10-point scale
The sensory profiles of the products are presented in the form of a radar graph.
This graph (FIG. 3) clearly shows the proximity of the cream of the invention in comparison with a dairy cream.

### Example 7

Viscosity measurements at 4° C. were carried out on one of the examples of the invention (example 1) in comparison with a commercial thick dairy cream.
The measurements are made with a rheometer equipped with a plane cone geometry of 2 degrees of angle and 50 mm diameter. One milliliter of sample is deposited and the viscosity value is read after 2 minutes under shear at 10 s⁻¹.
The results are shown in the diagram in FIG. 4. The viscosity of the product resulting from the invention is close to the viscosity of a commercial thick dairy cream.
The viscosity of the product of the invention can be modulated as required by adjusting the formulation and manufacturing method parameters.

1. A vegetable food product analogous to a dairy cream comprising:
crushed nuts, with the addition of:
at least one vegetable fat;
at least one source of starch;
at least one natural acidifying ingredient;
optionally, at least one source of vegetable food fibres;
and
water;
wherein the vegetable food product contains no added additives.

2. The vegetable food product according to claim 1, wherein the vegetable food product has a protein content greater than or equal to 3.5%.

3. The vegetable food product according to claim 1, not comprising protein concentrate and/or isolate.

4. The vegetable food product according to claim 1, wherein the crushed nuts are in the form of almond puree, with the further addition of:
the at least one vegetable fat selected from the vegetable oils liquid at 20° C., including rapeseed oil, sunflower oil, olive oil, grape seed oil, linseed oil, hemp oil and mixtures thereof;
optionally, ferments;
the at least one source of vegetable food fibres, selected from soluble fibres, including chicory fibres, resistant dextrins and psyllium or other mucilaginous fibres including linseed or chia seed fibres, and mixtures thereof.

5. The vegetable food product according to claim 1, wherein the crushed nuts are in the form of almond puree, with the further addition of ferments.

6. The vegetable food product according to claim 1, not comprising soybean.

7. The vegetable food product according to claim 1, further comprising (percentages expressed by weight with respect to the total weight of the product):
from 5 to 30% of crushed nut puree;
from 5 to 40% of vegetable fat;
from 0.5% to 10% of a starch source;
up to 30% of other raw materials, including vegetable or fruit purees or pieces, cereals, seeds, aromas, coloring foods, sugars, Lithothamnium powder or herbs;
up to 8% of vegetable food fibres;
optionally, a natural source of calcium, of the Lithothamnion type, at a content of between 0.5 and 1%;
up to 3.5% of acidifier of the concentrated lemon juice type;
up to 1.5% of food salt;
optionally, up to 1% of ferments; and
water, between 50% and 75%.

8. The vegetable food product according to claim 1, wherein the vegetable food product has:
a dry extract content of between 20 and 50%;
a pH between 4.0 and 5.2; and
characteristics of a fresh dairy product, including white color, smooth appearance, very smooth and dispersing texture in the mouth, from liquid to thick depending on the type of cream desired and a fresh to fermented/acidic taste.

9. The vegetable food product according to claim 1, wherein the nut is almond.

10. A vegetable food product according to claim 1, wherein the vegetable fat is a vegetable oil liquid at 20° C.

11. The vegetable food product according to claim 10, wherein the vegetable oil liquid at 20° C. is chosen from rapeseed, sunflower or olive oil or their mixture.

12. The vegetable food product according to claim 1, wherein the starch source is a rice flour and/or a potato or manioc fecula.

13. The vegetable food product according to claim 12, wherein the rice flour is pregelatinized.

14. The vegetable food product according to claim 1, wherein the vegetable food fibres are chosen from the soluble fibres, including chicory fibres, resistant dextrins and psyllium or other mucilaginous fibres including linseed or chia seed fibres, and mixtures thereof.

15. A method for preparing the product according to claim 1, comprising the following steps:
A) optionally, preparing a fermented vegetable raw material by fermentation of a part or all of the crushed nuts, in their rehydrated and thermally treated form prior to the inoculation of the ferments;
B) mixing the raw materials, comprising the fermented vegetable raw material obtained in step A), via a vigorous shearing, and optionally preheating;
C) thermal treating the mixture at a temperature between 75 and 140° C.;
D) optional degassing and homogenizing;
E) optionally, adding raw materials, including vegetable;
wherein steps E) and F) can be reversed;
F) dosing the finished product;
G) optionally, cooling between 4 and 10° C.;
H) optionally, in the case of a dosing in an intermediate container, adding other raw materials, including vegetable, aromatizing or coloring and/or ferments, followed by cold dosing of the product in its final packaging.

16. The vegetable food product according to claim 1, wherein the nuts are in the form of a puree.

17. The vegetable food product according to claim 1, wherein the vegetable food product has a protein content between 3.5 and 6%.

18. The vegetable food product according to claim 1, wherein the vegetable food product has a protein content between 3.5 and 5%.

19. The vegetable food product according to claim 1, wherein the vegetable food product has a protein content between 4 and 6%.

20. The vegetable food product according to claim 1, wherein the vegetable food product has a protein content between 4 and 5%.
